(19) United States
(12) Patent Application Publication
(10) Pub. No.: US 2025/0272117 A1
(43) Pub. Date: Aug. 28, 2025

(54) SYSTEMS AND METHODS FOR GENERATING CONTEXT-AWARE CONTENT ACROSS APPLICATIONS

(71) Applicant: Google LLC, Mountain View, CA (US)

(72) Inventors: Behnoosh Hariri, New York, NY (US); Albert Orriols Puig, Los Altos, CA (US); Grace Sytin Shih, Cupertino, CA (US); Blake Kaplan, New York, NY (US); Yong Fan, Fremont, CA (US); Ashley Wangui Njoroge, Brooklyn, NY (US); William Timothy Hui, Sunnyvale, CA (US); John Gabriel D'Angelo, New York, NY (US); Tiffany Wang-Ting Lim, Brooklyn, NY (US); Matthew Robert Hughes, Brooklyn, NY (US); Chang Li, New York, NY (US); Mingjie Kenneth Lim, New York, NY (US)

(21) Appl. No.: 18/586,750

(22) Filed: Feb. 26, 2024

(51) Int. Cl. G06F 9/451; G06F 9/54

(52) U.S. Cl. CPC G06F 9/451; G06F 9/54

(57) ABSTRACT

A computer-implemented method for generating context-aware content includes providing a user interface to a user computing system, where the user interface has a first content generation environment and a model interaction environment within a first item of a first application. Further, the computer-implemented method includes providing first content associated with the first application automatically to a generative model. Moreover, the computer-implemented method includes receiving context-aware content generated by the generative model based at least in part on the first content. Additionally, the computer-implemented method includes presenting the context-aware content using the model interaction environment of the user interface.

### FIELD

The present disclosure relates generally to productivity suites, having a plurality of applications. More particularly, the present disclosure relates to an assistant for generating context-aware content, where the assistant is accessible across applications, such as across applications of a productivity suite.

### BACKGROUND

Productivity suites, such as cloud-based productivity suites, typically include multiple applications for users to create and manage different content, such as documents, presentations, email, calendars, meetings, and/or the like. In some instances, the applications allow for multiple users to collaboratively create and manage the different content. Various tools are available within online productivity suites to assist users in generating, creating, and/or editing different types of content or performing tasks. However, users may not be familiar with the most effective approach to use the tools to achieve their specific goal. As such, a user may switch between multiple applications within and/or external to the productivity suite to find additional information, use formatting and editing tools manually, and/or the like to accomplish goals. However, such switching between different applications and manual tool usage is often repetitive, time-consuming, and inefficient in both computing-power and workflow productivity. Moreover, when generative models are accessible within applications, the generative models may generate content that is not relevant to what a user is doing. As such, a user may prompt the model multiple times for a single task and/or may manually edit or format content generated by the model, which can also be repetitive, time-consuming, and inefficient in both computing-power and workflow productivity.

As such, systems and methods for generating context-aware content across applications, such as different applications of a productivity suite, that reduce or eliminate such switching events, manual editing, and iterative prompting would be beneficial in the technology.

### SUMMARY

Aspects and advantages of embodiments of the present disclosure will be set forth in part in the following description, or can be learned from the description, or can be learned through practice of the embodiments.

One example aspect of the present disclosure is directed to a computing system for generating context-aware content. The computing system may include one or more processors and one or more non-transitory computer-readable media that collectively store instructions that, when executed by the one or more processors, cause the computing system to perform operations. The operations may particularly include providing a user interface to a user computing system, where the user interface may include a first content generation environment and a model interaction environment within a first item of a first application. The operations may further include providing first content associated with the first application automatically to a generative model. Moreover, the operations may include receiving context-aware content generated by the generative model based at least in part on the first content. Additionally, the operations may include presenting the context-aware content using the model interaction environment of the user interface.

Another example aspect of the present disclosure is directed to a computer-implemented method for generating context-aware content. The computer-implemented method may include providing, by a computing system, a user interface to a user computing system, where the user interface may include a first content generation environment and a model interaction environment within a first item of a first application. Further, the computer-implemented method may include providing, by the computing system, first content associated with the first application automatically to a generative model. Moreover, the computer-implemented method may include receiving, by the computing system, context-aware content generated by the generative model based at least in part on the first content. Additionally, the computer-implemented method may include presenting, by the computing system, the context-aware content using the model interaction environment of the user interface.

Another example aspect of the present disclosure is directed to one or more non-transitory computer-readable media that collectively store instructions that, when executed by one or more computing devices, cause the one or more computing devices to perform operations. Particularly, the operations may include providing a user interface to a user computing system, where the user interface may include a first content generation environment and a model interaction environment within a first item of a first application. Further, the operations may include providing first content associated with the first application automatically to a generative model. Moreover, the operations may include receiving context-aware content generated by the generative model based at least in part on the first content. Additionally, the operations may include presenting the context-aware content using the model interaction environment of the user interface.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system for generating context-aware content across applications according to example embodiments of the present disclosure.

FIG. 1B depicts a block diagram of an example computing device for generating context-aware content across applications according to example embodiments of the present disclosure.

FIG. 1C depicts a block diagram of an example computing device for generating context-aware content across applications according to example embodiments of the present disclosure.

FIG. 2 depicts a block diagram of an example system for generating context-aware content across applications of a productivity suite according to example embodiments of the present disclosure.

FIG. 3 depicts a block diagram of an example for generating context-aware content across applications according to example embodiments of the present disclosure.

FIGS. 4A-4B depict illustrations of example aspects of a user interface of a first application of a productivity suite during generation of context-aware content according to example embodiments of the present disclosure.

FIGS. 5A-5C depict illustrations of further example aspects of a user interface of a first application of a productivity suite during generation of context-aware content according to example embodiments of the present disclosure.

FIGS. 6A-6B depict illustrations of example aspects of a user interface of another application of a productivity suite during generation of context-aware content according to example embodiments of the present disclosure.

FIGS. 7A-7B depict illustrations of example aspects of a user interface of a further application of a productivity suite during generation of context-aware content according to example embodiments of the present disclosure; and

FIG. 8 depicts a flow chart diagram of an example method for generating context-aware content across applications according to example embodiments of the present disclosure.

Reference numerals that are repeated across plural figures are intended to identify the same features in various implementations.

### DETAILED DESCRIPTION

### Overview

Generally, the present disclosure is directed to systems and methods for generating context-aware content across applications, such as across different applications of a productivity suite. More particularly, the systems and methods disclosed herein provide a guiding digital assistant accessible from, and connected across, different applications of a productivity suite, where the digital assistant uses the context of the application currently being used, the user's actual work product development process within the application currently being used, and/or the user's work in other applications of the productivity suite to guide the user to more effectively prompt the digital assistant and/or to provide more effective generative content.

For instance, in some cases, the guiding digital assistant may monitor a user's content generation within an application to proactively suggest next steps. For example, if a user is writing a children's story in a document-based application, the guiding digital assistant may follow a user's development of the story, understand the context of the story and the document-based application, and proactively suggest what may happen next and/or suggest actions to be taken with the digital assistant to support the user's development.

In some instances, the user interface for the guiding digital assistant for interacting with the guiding digital assistant may be substantially similar across different applications, but the interactions may be modified for each application. For instance, the guiding digital assistant may suggest a prompt for the guiding digital assistant to create speaker notes when in a presentation-based application, suggest a prompt for the guiding digital assistant to change heading formatting or to add a new section when in a document-based application, and/or the like. For this purpose, a cross-platform controller can be embedded within different applications (on web or mobile) and offer a range of capabilities (independent plug-ins) that can be optionally enabled by/for different hosts. The cross-platform controller may connect to the user interface for the guiding digital assistant, manage the user conversation history with the guiding digital assistant, manage user triggers for fetching proactive suggestions, manage communications with the server (e.g., with the AI server, the productivity suite server, and/or the like), and/or process Al-generated responses for different content types.

In one or more instances, the guiding digital assistant may be able to decide an appropriate source(s) based on a prompt and surface the source(s) used to generate the content to a user. For example, users can write a prompt explicitly asking the guiding digital assistant to perform an action based on a particular source, where the guiding digital assistant may locate the appropriate source item, perform the action, then link the source item to the result. If no explicit reference to a source is provided, the guiding digital assistant will find related sources with similar content (e.g., from emails, documents, etc. within the productivity suite and/or from other sources, such as the internet), perform the action, then link the source(s) to the result.

Online productivity suites provide tools for users to perform a variety of tasks, such as creating different content types, searching for information, or performing collaborative actions. Various AI and non-AI tools are available within online productivity suites to assist users in generating or creating different types of content or performing tasks. However, users may not be familiar with the most effective approach to use the suite tools to achieve their specific goal. For example, when writing a report for a project, a user may spend time thinking about the structure of the report, then look up related documents, meetings, chats, etc. related to the project, and then write the report. As such, a user may switch between multiple applications to find sources and actually create the report. Aspects of the present disclosure provide a number of technical effects and benefits. As one example technical effect and benefit, implementations of the present disclosure guide users by providing context-aware suggestions on next-steps and information from relevant sources, optimized for a particular application, without requiring a user to navigate away from a current application or view irrelevant options, which can substantially reduce the time required by users and the number of iterative prompts to the guiding digital assistant. In turn, this eliminates the expenditure of substantial quantities of computer resources that a user would otherwise use (e.g., compute cycles, power, memory, etc.). Further, by reducing the time expense of users, implementations of the present disclosure can increase efficiency across a number of use-cases (e.g., software engineering, medical research, citing documents for research papers, etc.).

With reference now to the Figures, example embodiments of the present disclosure will be discussed in further detail.

### Example Devices and Systems

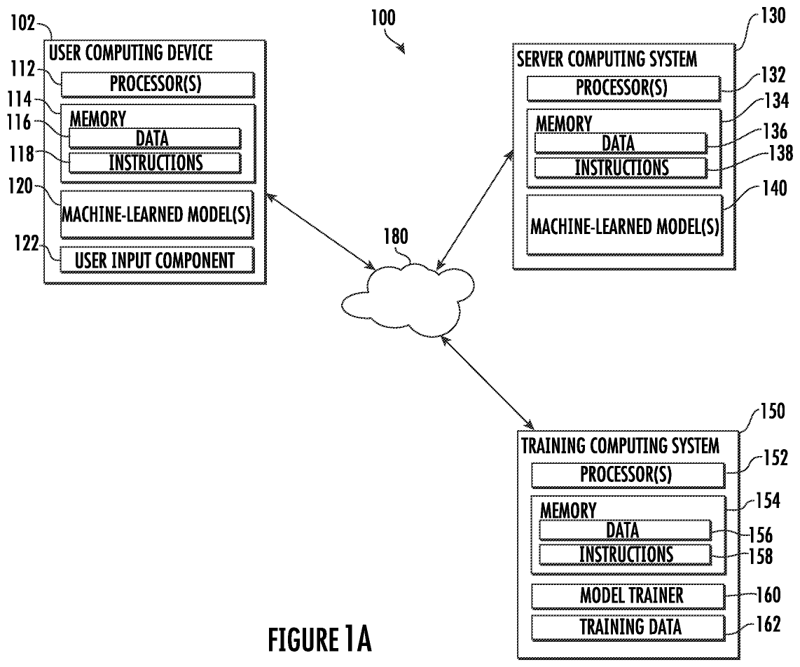

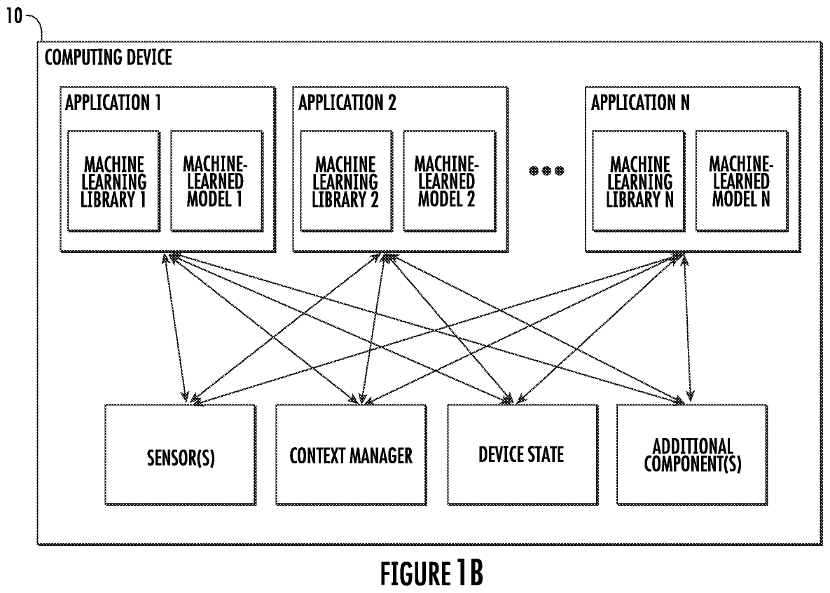

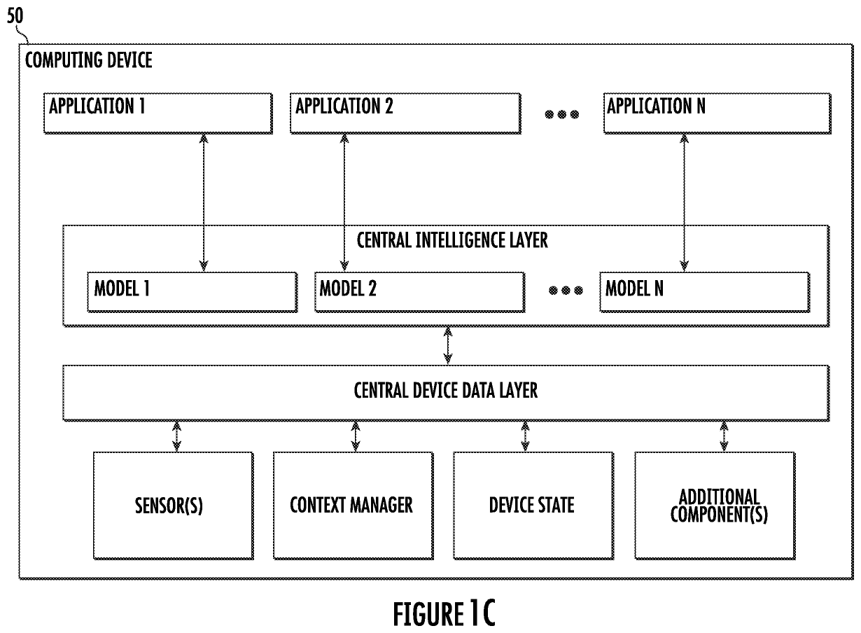

FIG. 1A depicts a block diagram of an example computing system 100 for generating context-aware content across applications, such as across applications of a productivity suite, according to example embodiments of the present disclosure. The system 100 includes one or more user computing devices 102, a server computing system 130, and a training computing system 150 that are communicatively coupled over a network 180.

The user computing device(s) 102 can be any type of computing device(s), such as, for example, a personal computing device(s) (e.g., laptop or desktop), a mobile computing device(s) (e.g., smartphone or tablet), a gaming console(s) or controller(s), a wearable computing device(s), an embedded computing device(s), or any other type of computing device(s).

The user computing device(s) 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device(s) 102 to perform operations.

In some implementations, the user computing device(s) 102 can store or include one or more models 120. For example, the models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example models 120 are discussed with reference to FIGS. 1B-7B.

In some implementations, the one or more models 120 can be received from the server computing system 130 over network 180, stored in the user computing device memory 114, and then used or otherwise implemented by the one or more processors 112. In some implementations, the user computing device(s) 102 can implement multiple parallel instances of a single model 120 (e.g., to perform parallel context-aware content generation across multiple applications).

More particularly, the generative model 120 can be trained to process content associated with an application automatically provided to the generative model 120 and generate context-aware content based at least in part on the automatically provided content associated with the application. The application may be part of a productivity suite, for instance, such that data may be shared across the applications of the productivity suite easily, such as without substantial reformatting, without additional permission requests, and/or the like. However, in some instances, the application may not be part of a productivity suite but, in some instances, may be connectable to a productivity suite and/or to the generative model 120. The content associated with the application automatically provided to the generative model 120 may include the type of the application (e.g., a document-based application, an email application, a presentation application, a calendar application, a virtual meeting application, a photo application, and/or the like), functionalities associated with the application, content within the application (e.g., user-generated content, authorized users, editing history, conversation histories, and/or the like). Examples of context-aware content generated by the generative model 120 based at least in part on the automatically provided content may include a summary of the automatically provided content, suggested prompt(s) for submission to the generative model 120, or responsive content (e.g., text, images, calendar events, and/or the like) answering user-prompt(s).

Additionally, or alternatively, one or more models 140 can be included in or otherwise stored and implemented by the server computing system 130 that communicates with the user computing device(s) 102 according to a client-server relationship. For example, the models 140 can be implemented by the server computing system 130 as a portion of a web service (e.g., a productivity suite service). Thus, one or more models 120 can be stored and implemented at the user computing device(s) 102 and/or one or more models 140 can be stored and implemented at the server computing system 130.

The user computing device(s) 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1B-7B.

The user computing device(s) 102 and/or the server computing system 130 can train the model(s) 120, 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned model(s) 120, 140 stored at the user computing device(s) 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the model(s) 120, 140 based on a set of training data 162. In some implementations, if the user has provided consent, the training examples can be provided by the user computing device(s) 102. Thus, in such implementations, the model 120 provided to the user computing device(s) 102 can be trained by the training computing system 150 on user-specific data received from the user computing device(s) 102. In some instances, this process can be referred to as personalizing the model. In some instances, the model 120 may be trained on training examples from the productivity suite, such as across different types of applications, across different users of the productivity suite, and/or across different content types found within different applications (e.g., words, images, tables, etc.).

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a semantic intent output. As another example, the machine-learned model(s) can process the speech data to generate a prediction output.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

FIG. 1A illustrates one example computing system that can be used to implement the present disclosure. Other computing systems can be used as well. For example, in some implementations, the user computing device(s) 102 can include the model trainer 160 and the training dataset 162. In such implementations, the models 120 can be both trained and used locally at the user computing device(s) 102. In some of such implementations, the user computing device(s) 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

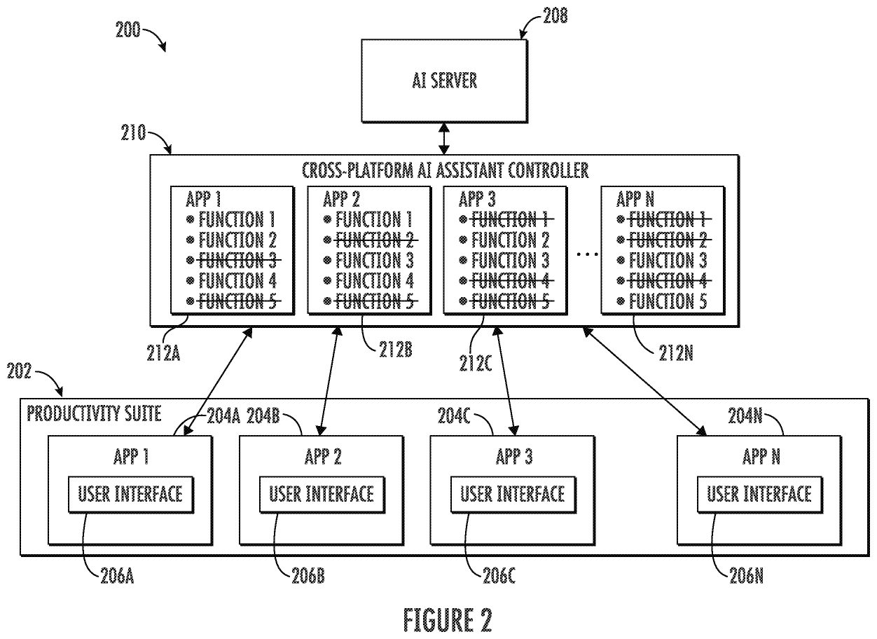

FIG. 2 depicts a block diagram of an example system 200 for generating context-aware content across applications, such as across applications of a productivity suite according to example embodiments of the present disclosure. In particular, the productivity suite 202 may include or host a plurality of applications, such as a first application 204A, a second application 204B, a third application 204C, and so on through a suitable number (Nth) application 204N, where the different applications may be connected to allow data to be shared. For instance, the productivity suite 202 may allow the different applications 204A, 204B, 204C, 204N to share information without significant additional permissions and/or without significant additional steps by a user(s) (e.g., data reformatting, permissions, and/or the like). In general, such productivity suites, such as the productivity suite 202, may be downloaded onto and run on personal computing devices (e.g., user computing device(s) 102 in FIG. 1A, and/or any other suitable user computing device(s)), may be cloud or internet-based and run on a server computing device(s) (e.g., server computing device 130 in FIG. 1A, and/or another server based computing device(s)), and/or may be a combination of downloaded and cloud or internet-based. The productivity suite 202 may include any suitable combination of applications, such as a document-based word-processing application, a cell-based application, an email application, a presentation application, a calendar application, a virtual meeting application, a photo application, and/or the like. Each of the applications 204A, 204B, 204C, 204N of the productivity suite 202 may have a respective user interface 206A, 206B, 206C, 206N allowing an authorized user(s) to create, access, edit, and/or the like content within the application. In some instances, one or more of the applications 204A, 204B, 204C, 204N particularly allow for collaborative files or objects, such as documents, spreadsheets, presentation slide decks, emails, calendar events, and/or the like, in which content is accessible and/or editable by multiple authorized users.

In some instances, while not shown, the productivity suite 202 may be in communication with one or more external applications, outside of the productivity suite. In general, the external application(s) may similarly be any suitable type of application or combination of applications (such as a document-based application, a cell-based application, an email application, a calendar application, a virtual meeting application, a photo application, and/or the like) that is not necessarily optimized to communicate with the applications of the productivity suite. For instance, the external application(s) may be created by a different party than the one that created or hosts the productivity suite 202, may have been created using a different platform than the one used for the productivity suite 202, may be optimized for different devices than for the productivity suite 202, and/or the like. The external application(s) may similarly be configured to provide a user interface to allow authorized users for the external application(s) to create, access, edit, and/or the like content within the external application(s). In some instances, the external application(s) may also support collaborative generation or development environments, in which content is accessible and/or editable by multiple authorized users for the external application(s).

Users must often switch between different applications to accomplish tasks. For instance, a user may start in a first application to perform a first task and then switch to another application to perform a second task based on the first task or something else in the first application. Generally, switching back and forth is time consuming, as users must often spend substantial quantities of time and effort navigating between the different applications to accomplish tasks, where the tasks may be simple, yet repetitive. Such switching back and forth between applications also wastes substantial quantities of computer resources (e.g., compute cycles, power, memory, etc.). Similarly, a user may perform repetitive tasks within an application, such as formatting. A digital assistant (e.g., a generative model stored and accessible from a server 208) may be configured to be accessible across applications to help reduce switching back and forth between applications and to reduce repetitive tasks within an application. However, different applications may have different functions, such as for different formatting options, different content areas, different conversation flows, and/or the like. For instance, a presentation application may have a speaker notes section for each presentation slide, presentation transition actions, and different layout options that would not be present within a typical document-based application. As such, existing digital assistants may generate content that is not particularly relevant to the application being used.

Thus, as will be described below in greater detail, a cross-platform controller 210 may be provided between applications (e.g., applications 206A, 206B, 206C, 206N of the productivity suite 202) and a generative model (e.g., the server 208 supporting such generative model) for providing context to the generative model based on content associated with the application currently being used, which improves the relevance of the generated content. In some instances, the cross-platform controller 210 connects to the different applications and manages the interactions with the model for the individual applications, including managing the conversation history between the user and the model, managing user triggers for fetching proactive suggestions, managing communications with the model, processing the generated responses by the model for the different applications. For this purpose, the cross-platform controller 210 may offer a range of capabilities or functions that can be optionally enabled for different applications (e.g., by the host(s) of the application(s)), which allows the interactions with the model to be customized for each application. For example, the cross-platform controller 210 may provide a number of different capabilities or functions (e.g., five functions including a first function (“function 1”), a second function (“function 2”), a third function (“function 3”), a fourth function (“function 4), and a fifth function (“function 5”)) that may be optionally enabled for each application. In the example shown, the first, second, and fourth functions are enabled in a first functions block 212A associated with the first application 204A, whereas the first, third, and fourth functions are enabled in a second functions block 212B associated with the second application 204B, the second and third functions are enabled in a third functions block 212C associated with the third application 204C, and the third and fifth functions are enabled in a further functions block 212N associated with the nth application 204N. It should be appreciated that while the examples described herein are discussed with reference to five functions, any suitable number of functions or functionalities may instead be provided and optionally enabled, such as only one, two, three, or four functions or six or more functions.

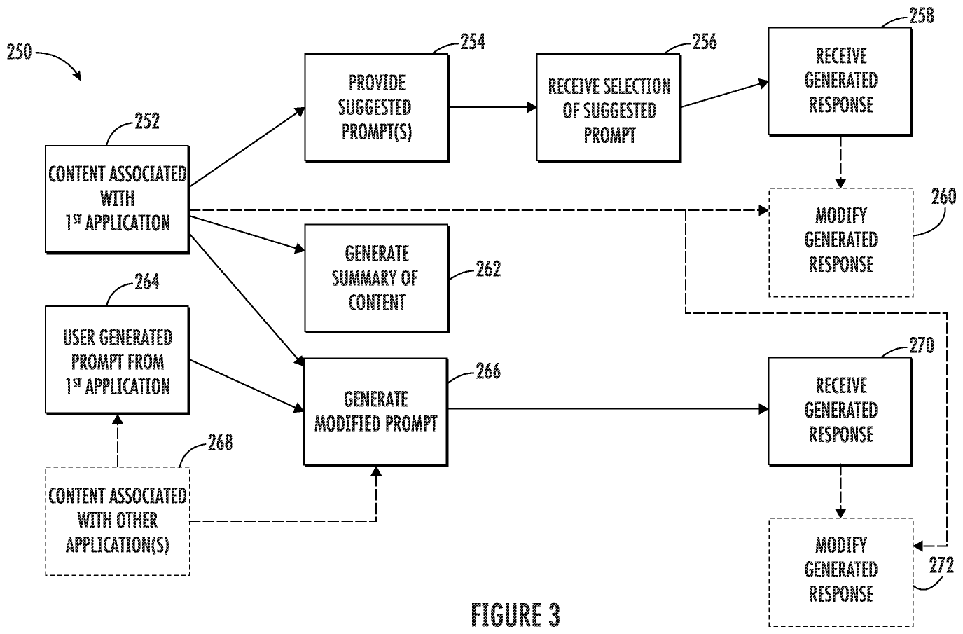

The functions or capabilities enabled for the different applications may be used to provide context aware prompt suggestions for prompting a generative model and/or to modify generated content from a generative model based on the context of the application. For instance, a block diagram of an example 250 for generating context-aware content across applications, such as across different applications of a productivity suite, is described with reference to FIG. 3. It should be appreciated that the example 250 may be implemented by the system 200 shown in FIG. 2.

As shown in FIG. 3, content 252 associated with a first application (e.g., a document-based application) may be used to provide one or more suggested prompts 254, where the suggested prompt(s) 254 may be used to prompt a model to generate content. In some instances, the content 252 associated with the first application may be a type of the first application (e.g., document-based), the enabled functions for the first application (e.g., the first function, the second function, and the fourth function in FIG. 2), and/or user actions within the first application (e.g., content development by users within the first application, user formatting within the first application, revisions by different users within the first application, conversations between users within the first application, and/or the like). In one or more instances, the suggested prompt(s) 254 may be provided proactively to a user, without a user having to ask for suggested prompts, which helps guide a user into effectively using the generative model. In some instances, the suggested prompt(s) 254 is generated by the generative model. In such instances, the content 252 may be automatically supplied to the generative model (e.g., to the server 208 hosting the model) for the generative model to use to generate the suggested prompt(s) 254. In some instances, the content 252 may be automatically supplied, for example, by the cross-platform controller 210 to the generative model.

Additionally, or alternatively, in some instances, the suggested prompt(s) 254 is one or more suggested prompts selected from predetermined or predefined suggested prompt(s). For instance, the predetermined or predefined suggested prompt(s) 254 may be configured based on the enabled functions for the first application. In some instances, such predetermined or predefined suggested prompt(s) 254 may be stored with the enabled functions. As an example, if the first application is a document-based application, predetermined or predefined suggested prompt(s) 254 would not include a request for presentation slides or presentation notes. In one instance, the predetermined or predefined suggested prompt(s) may be determined based on the most popular prompts for the type of application across users. The suggested prompt(s) 254 may be provided to a user via a user interface of the first application for display and/or other form of communication to a user. In one or more instances, the results for such suggested prompt(s) 254 may be prefetched which may reduce the amount of time it takes to respond to the suggested prompt(s) 254 upon submission to the generative model.

As will be described below in greater detail, in some instances, the user interface for an application (e.g., user interface 206A, 206B, 206C, 206N in FIG. 2) may include a content generation environment within which a user may generate and format content and a model interaction environment configured for a user to interact with a generative model. In some instances, the content generation environment may be separate from the model interaction environment. In one or more instances, the model interaction environment may be accessible from within the content generation environment (e.g., using a trigger in-line within the content generation environment). In some instances, content generated by the model may be initially provided within the model interaction environment, but insertable upon user request within the content generation environment. In one instance, the suggested prompt(s) 254 may be provided within the model interaction environment of the user interface for display and/or other interaction with a user. The model interaction environment may be substantially similar or the same in appearance across the different applications, but the present method of generating context-aware content customizes the interaction with the model interaction environment for the different applications.

After the suggested prompt(s) 254 have been provided, a selection 256 of one of the suggested prompt(s) 254 may be received. For instance, a user may click or otherwise select one of the suggested prompt(s) 254 provided via the user interface of the first application (e.g., via the model interaction environment), where the selected suggested prompt 254 may then be provided to the generative model for the generative model to generate content based at least in part on the selected suggested prompt 254. In some instances, the cross-application controller 210 receives the selection 256 of the suggested prompt from the user interface of the first application then transmits the selected prompt 254 to the model (e.g., to the model server 208). After the selected suggested prompt is sent to the generative model, a generative or generated response 258 is received from the generative model in response to the selected suggested prompt and provided to the user via the user interface. As indicated above, in some instances, the generated response 258 may initially be provided via the model interaction environment, but insertable upon user request into the content generation environment. However, in other instances, the generated response 258 may be automatically provided (e.g., inserted in-line) within the content generation environment.

Generally, as the selected suggested prompt 254 was initially provided to the user based on the content 252, the generated response 258 generated by the generative model will be particularly relevant to the content 252. However, in some instances, the generated response 258 may be refined or modified before being provided to the user via the user interface of the first application being used. For instance, the cross-platform controller 210 may refine or modify the generated response 258 for the current application. For example, if the type of application is not supplied to the model, the generated response 258 may need to be better refined for the type of application (e.g., for functions of the application, to match formatting within the content generation environment, and/or the like). As such, in some instances, the cross-platform controller 210 may refine or modify the generated response 258 for the current application to create a modified generated response 260.

The content 252 associated with the first application may additionally, or alternatively, be used to proactively generate a summary 262, without waiting for a user to request the summary. For instance, the content 252 may include content generated by a user within the content generation environment and, optionally, associated information, such as recent edits, new access by one or more users, and/or the like. In some instances, the cross-platform controller 210 may provide the content 252 to the model. The content 252 may be fed to the generative model with a request to generate a summary 262 of the content 252. Once the summary 262 is generated, the summary 262 may be provided to a user via the user interface, such as within the model interaction environment. In some instances, the summary 262 may be updated as the user continues to create and edit within the content generation environment.

In one or more instances, a user may generate a prompt 264 from within the first application to be submitted to the model. In some instances, the user-generated prompt 264 may indicate a source for the model to use to generate content. For instance, the user-generated prompt 264 may explicitly cite a reference to use, such as a particular item accessible by or within the productivity suite (e.g., a document, an email, a presentation, and/or the like) other than the current item in the application being accessed, a link to a website, and/or the like. In some instances, the user-generated prompt 264 may implicitly cite a reference to use, where the implicit reference may be accessible by or within the productivity suite (e.g., a document, an email, a presentation, and/or the like) other than the current item in the application being accessed and/or the internet. For instance, an implicit reference may be searched for within the productivity suite and selected based on the other item having similar keywords from the prompt and/or the implicit reference meeting criteria within the prompt (e.g., the “most recently edited,” the “most recently accessed,” and/or like). In some instances, if no relevant implicit reference is found within the productivity suite, a source may then be searched for on the internet or database by the model.

When an explicit reference and/or implicit reference from within the productivity suite is cited, such reference(s) 268 may be passed along with the user-generated prompt 264 to generate a modified prompt 266, where the modified prompt 266 may be provided to the model for the model to use to generate a response 270. In one or more instances, the modified prompt 266 may also be based at least in part on the content 252 associated with the first application. More particularly, in some instances, functionalities of the first application may be passed along with the user-generated prompt 264 and the reference(s) 268 to create the modified prompt 266. In some instances, the cross-platform controller 210 creates the modified prompt 266. After the modified prompt 266 is generated, the modified prompt 266 is submitted to the model. Generally, a response generated by the model in response to the modified prompt 266 is more likely to be relevant to the particular context of the first application than if the user-generated prompt 264 were submitted to the model without being modified. After a generated response 270 is created in response to the modified prompt 266, the generated response 270 may be refined and/or modified, similar to as discussed above for the modified generated response 260, before being provided to a user via the user interface for the first application.

It should be appreciated that the example 250 shows that context-aware content may be generated using a digital assistant across different applications without a user having to navigate away from the application the user is working within, and without any significant additional inputs from the user, which can substantially reduce the time required by users to perform actions across applications. In turn, this eliminates the expenditure of substantial quantities of computer resources that a user would otherwise use (e.g., compute cycles, power, memory, etc.). Further, by reducing the time expense of users, implementations of the present disclosure can increase efficiency across a number of use-cases (e.g., software engineering, medical research, citing documents for research papers, etc.).

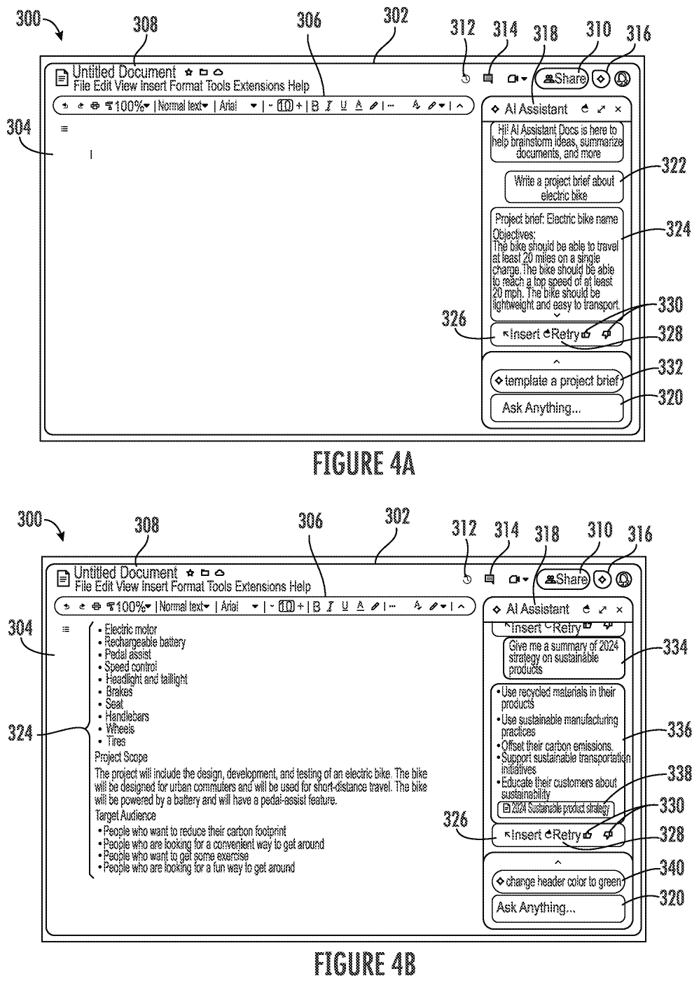

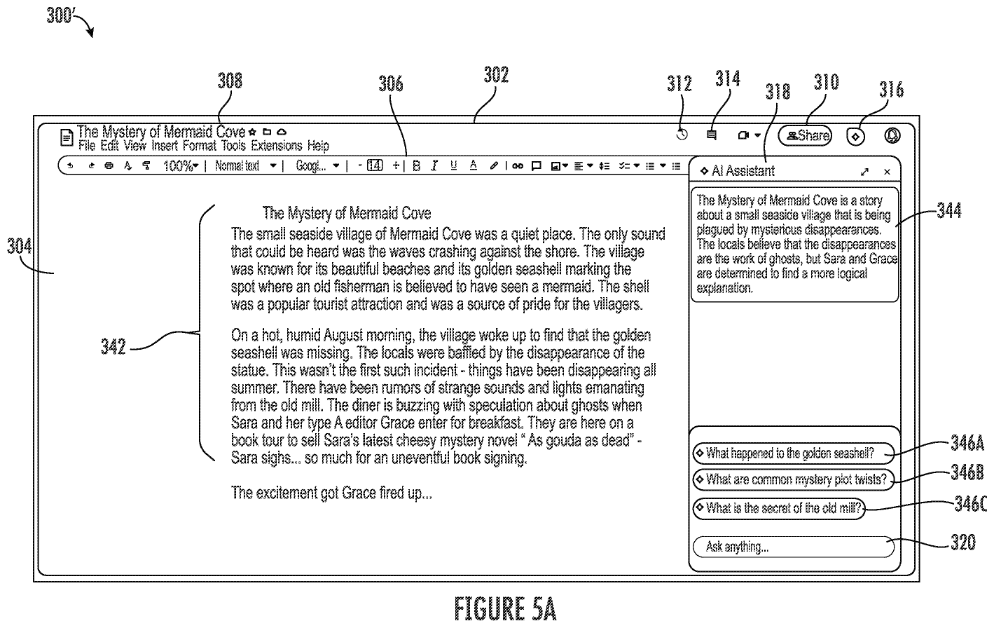

FIGS. 4A-7C illustrate different aspects of example interactions with user interfaces of different applications of a productivity suite during generation of context-aware content according to example embodiments of the present disclosure. For instance, FIGS. 4A-4B depict illustrations of example aspects of a user interface of a first application of a productivity suite during an interaction 300 for generation of context-aware content according to example embodiments of the present disclosure.

In particular, as shown in FIGS. 4A-4D, in some instances, the first application (e.g., first application 206A in FIG. 2) of the productivity suite may be a document-based application that includes or provides an item or object 302 (e.g., document file) displayed on a user interface (e.g., user interface 206A in FIG. 2), such as via a user interface of one of the user computing device(s) 102 of FIG. 1A. The object 302 may be a document having a content generation environment or workspace 304 configured to receive inputs (e.g., content such as text, images, and/or the like) from a user and provide or display such inputs in-line within the workspace 304. It should be appreciated that, as used herein, “in-line” is considered to mean content within or insertable into the workspace 304 such that it is subject to formatting rules of the workspace 304 and/or embedded into the workspace 304. For instance, the object 302 may provide one or more format selection interface elements 306 with which a user may interact for selecting or defining formatting rules (e.g., content level (e.g., heading, subheading, normal body, etc.), font style, font size, font emphasis (e.g., bold, italicize, underline, color, highlight), paragraph style, numbering, bulleting, and/or the like) for content (e.g., text) in-line within the workspace 304. The object 302 may further include a title field 308 for receiving and displaying a title (e.g., “Untitled Document”) for the particular object 302.

Further, the object 302 is configured as a collaborative workspace, which allows multiple authorized users to access (e.g., view) and/or edit content within the object 302 simultaneously. As such, the object 302 includes a share element 310 (e.g., button and/or the like) which may be interacted with (e.g., clicked on, hovered over, and/or the like) by a user for the user to view, add, and/or remove other authorized users and/or to assign different levels of authorization to each user (e.g., view only, permission to edit, permission to share, etc.). Moreover, the object 302 includes one or more further elements, where each of the further elements is associated with further information associated with the object 302. The further elements may be accessible directly from the toolbar above the workspace 304, from a list accessible from a floating icon within the workspace 304, from a list accessible from the toolbar, and/or any other suitable location. For example, a revision history element 312 and a conversation element 314 are independently accessible from icons displayed directly on the toolbar itself, however, such features may be otherwise accessible from the object 302. In general, when a user interacts with the revision history element 312, changes made to the object 302 (e.g., to the content within the workspace 304) by the different authorized users and, optionally, the time at which such change occurred, may be provided (e.g., displayed). Similarly, when a user interacts with the conversation element 314, comments made and/or resolved by the different authorized users and, optionally, the time at which comments were made and/or resolved, may be provided (e.g., displayed). It should be appreciated that any other suitable elements may be directly accessible from the toolbar.

Additionally, in accordance with aspects of the present subject matter, the object 302 may provide access to a generative model. For instance, the object 302 may include an assistant element 316 for accessing a model interaction environment 318, where the model interaction environment 318 acts as a guiding digital assistant that allows a user to communicate with the generative model. As described above, the model interaction environment 318 may be broken-out or separated from the rest of the general workspace 304. For example, in the illustrated embodiments, the model interaction environment 318 is configured as a side panel. However, it should be appreciated that the model interaction environment 318 may be provided in any other suitable format, such as a pop-up window, and/or the like and/or that the model interaction environment 318 may be interactable with from within the general workspace 304. In general, a user may type or otherwise provide a prompt within the model interaction environment 318, such as within a prompt field 320, where the prompt may then be submitted to the model (e.g., via the cross-application controller 210, as described above).

For instance, in the illustrated example in FIG. 4A, a user has submitted a prompt 322 (e.g., “Write a project brief about electric bike”) via the prompt field 320 in the model interaction environment 318. In some instances, as described above, the cross-platform controller 210 (FIGS. 2 and 3) may be configured to generate a modified user-generated prompt based on the prompt 322 and other information associated with the object 302. For instance, the cross-platform controller 210 may indicate to the generative model with the prompt 322 that the object 302 is an item of a document-based application. In response to the user-generated prompt 322 (and any additional information provided by the cross-platform controller 210), the generative model generates a generative response 324 (e.g., a project brief about electric bikes) which is provided within the model interaction environment 318. In some instances, as also described above with reference to FIGS. 2 and 3, the cross-platform controller 210 may modify the generative response 324 based at least in part on the context of the object 302 (e.g., that the object 302 is an item of a document-based application). For instance, if the context associated with the object 302 was not passed along with the user-generated prompt 322 to the generative model, the generative response may not be relevant to the context associated with the object 302. As such, the generative response 324 may be modified before being provided to the user via the model interaction environment 318. If a user is satisfied with the generative response 324, the user may request that the generative response 324 be inserted into the workspace 304, such as by interacting with the insertion request element 326 (e.g., button labeled “Insert” within the model interaction environment 318 and associated with the generative response 324). If the user wants to prompt the model to generate a new response based on the prompt 322, the user may interact with a re-submission element 328 (e.g., button labeled “Retry” within model interaction environment 318 and associated with the generative response 324). In some instances, the original generative response 324 is provided with the prompt 322 to the model with the request to generate a new generative response. The user may also provide quality feedback to the model. For instance, the user may indicate if the generative response 324 is relevant, correct, etc. or irrelevant, incorrect, etc. by interacting with feedback elements 330 (e.g., a thumbs-up button for positive feedback and a thumbs-down button for negative feedback within model interaction environment 318 and associated with the generative response 324).

Moreover, in some instances, the user-generated prompt may indicate a source for the generative model to use to generate content. For instance, as shown in FIG. 4B, another user-generated prompt 334 is provided, where the prompt 334 provides an action to be performed (e.g., “provide a summary”) and indicates a source (e.g., “2024 strategy on sustainable products”) for the action. In such example, the source is only implicitly provided, meaning that the file location for the source is not explicitly provided (e.g., linked) to the prompt 334. In such instance, content within the first application and other accessible applications used by the user (e.g., within the productivity suite) may be searched for that correspond to the implicit source. For example, other objects (e.g., documents) within the first application and/or other objects within other applications (e.g., emails within an email application, spreadsheets within a spreadsheet application, presentations within a presentation application, and/or the like) may be searched for (e.g., by the cross-platform controller and/or the generative model) that have content with similar keywords and/or context (e.g., accessible users, application type, and/or the like) to the implicit source. In some instances, the most recently edited or accessed item with similar keywords may be identified to use as the implicit source material. In response to the prompt 334 (and any additional contextual information provided by the cross-platform controller 210, similar to as described above for FIG. 4A), the generative model generates a generative response 336 (e.g., a summary of the implicit source) which is provided within the model interaction environment 318 in addition to an indication 338 of the source. In some instances, the indication 338 of the source specifies the application type for the source (e.g., the document-based application), the title of the source (e.g., “2024 Sustainable product strategy”), a link to the source (e.g., hyperlink to the source file location), and/or the like. While the example source provided in FIG. 4B is another document in the first application, it should be appreciated that the source may be any other suitable source, such as an item of another type of application, a webpage, and/or the like. Moreover, while the example source provided in FIG. 4B is an example of an implicit source, it should be appreciated that a user may explicitly define the source to be used within the prompt field 320 and/or any additional guiding fields (e.g., drop down fields, free-form fields, file selection fields, and/or the like).

Additionally, in accordance with aspects of the present subject matter, one or more proactive or suggested prompts may be automatically provided based at least in part on the context associated with the object 302, where each suggested prompt(s) is submittable to the generative model upon request by a user. For instance, in FIG. 4A, no content is present within the workspace 304, but a suggested prompt 332 for the model (e.g., labeled “template a project brief”) is presented within the model interaction environment 318. As discussed above, the suggested prompt(s), such as the suggested prompt 332, may be based at least in part on context automatically provided, such as a type of the first application (e.g., document-based application), such as common prompts for such type of application, the enabled functions for the first application, and/or the like. Similarly, in FIG. 4B, content is provided within the workspace 304 (e.g., the inserted generative response 324), and a different suggested prompt 340 (e.g., labeled “Change header color to green”) is presented within model interaction environment 318 based at least in part on such content. For instance, it may be detected that the content is within the workspace 304 (e.g., the inserted generative response 324) has a plurality of headers, as such, suggested prompts may be provided based on the presence of the headers. In some instances, the content within the workspace 304 is automatically provided to the model (e.g., by the cross-platform controller 210) for the model to parse the content and identify relevant details (e.g., headers, body content, and/or the like) and generate or select suggested prompts, such as the suggested prompt 340. However, in some instances, the cross-platform controller 210 may identify and provide the suggested prompt 340 based on a type of the first application (e.g., document-based application), such as common prompts for such type of application, the enabled functions for the first application, the presence of content, the type of content (e.g., tables, paragraphs, pictures, etc.), and/or the like. Upon selection of the suggested prompt, the prompt may be provided to the model for content generation and/or for modifying existing content within the workspace 304.

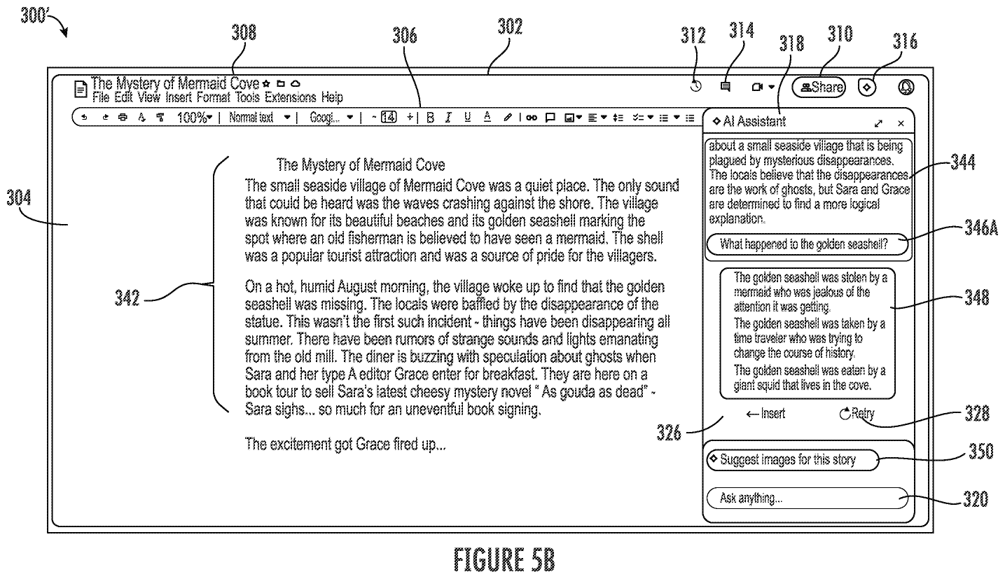

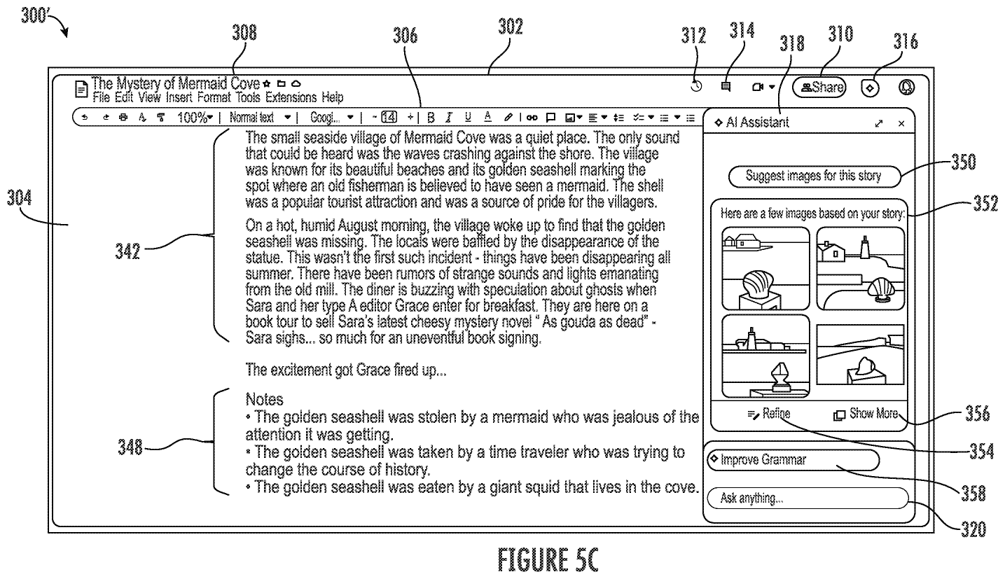

Turning to FIGS. 5A-5C, illustrations of further example aspects of a user interface of a first application of a productivity suite during another interaction 300′ for generation of context-aware content are provided in accordance with aspects of the presents subject matter. For example, the item 302 of the first application (e.g., document-based application) of the productivity suite is being used in the interaction 300′ by a user to write a story (e.g., “The Mystery of Mermaid Cove”). As the user writes the story, the user-generated content 342 (e.g., the story) is automatically provided to the generative model (e.g., via the cross-platform controller 210, as described above with reference to FIG. 3) and, in response, the generative model provides a summary 344 of the user-generated content 342 (e.g., a summary of the plot of “The Mystery of Mermaid Cove”) within the model interaction environment 318, as best shown in FIG. 5A.

In some embodiments, the user-generated content 342 may be automatically provided by the cross-platform controller 210 with a request by the cross-platform controller 210 to generate the summary 344. In some instances, the automatic request for a summary of the content 342 may be selected by the cross-platform controller 210 based at least in part on the type of the application (e.g., the cross-platform controller 210 assumes the intent based on the application being a document-based application). However, in other embodiments, the user-generated content 342 may be provided with the context of the application and the generative model may decide, based on the content and/or the context of the application, to provide a summary of the content 342.

In some instances, in addition, or in alternative, to the summary 344, the model may provide suggested prompts based at least in part on the content 342 which may be submitted to the generative model. For example, the model may provide suggested prompts for writing about plot points of the story, such as a first story prompt 346A (e.g., “What happened to the golden seashell?”), a second story prompt 346B (e.g., “What are common mystery plot twists?”), and a third story prompt 346C (e.g., “What is the secret of the old mill?”). Upon selection of one of the story prompts, the story prompt may be submitted to the generative model and the generative model may generate one or more responses, which may be provided via the model interaction environment 318. For instance, in response to selection of the first story prompt 346A (e.g., “What happened to the golden seashell?”), the generative model provides a generative response 348 with one or more plot options (e.g., “The golden seashell was stolen by a mermaid . . . ,” “The golden seashell was taken by a time traveler . . . ,” and “The golden seashell was eaten by a giant squid . . . ”) which may be selected by a user for insertion (e.g., by clicking the insertion element 326).

In some instances, the suggested prompts may suggest another content type to be generated based at least in part on the content 342. For instance, as shown in FIG. 5B, the content type of the content 342 is text, whereas a suggested prompt 350 is provided via the model interaction environment 318 for suggesting images (e.g., “Suggest images for this story”). Upon selection of the suggested prompt 350, the suggested prompt 350 may be submitted to the generative model, and the generative model may generate a response 352 that is responsive to the suggested prompt 350. For instance, as shown in FIG. 5C, the generative response 352 may include images generated and/or found by the model in response to the suggested prompt 350. Similar to as described above, the suggested prompt 350 may be provided with context to the model, such as the content 342 within the workspace 304 (optionally including inserted generative content 348), the type of the application, and/or the like. If the user wants to prompt the model to refine one of the images of the generative response 352, the user may interact with a refine element 354 (e.g., button labeled “Refine” within model interaction environment 318 and associated with the generative response 352). In some instances, one or more refinement fields (e.g., drop down fields, free-form fields, file selection fields, and/or the like) may be accessed for the user to indicate desired refinement (e.g., make the seashell bigger, add a lighthouse, add a mermaid, higher resolution, lower resolution, etc.). In one instance, the user may indicate desired refinement directly within the prompt field 320. Similarly, if the user wants to see more or have the model generate other options, the user may interact with an expand element 356 (e.g., labeled “Show More” within model interaction environment 318 and associated with the generative response 352). Similar to the re-submission element 328, in some instances, the original generative response 352 is provided with the prompt 350 to the model with the request to generate a more and/or new generative responses. Moreover, while not shown, any other suitable interaction elements may be provided with different generated content types, such as the insertion request element 326, the re-submission element 328, the feedback element(s) 330, and/or the like.

Similar to the suggested prompt 340 in FIG. 4B, FIG. 5C shows another example of a suggested prompt 358 for modifying existing content within the workspace. For instance, the suggested prompt 358 is to edit (e.g., “Improve grammar”) the content within the workspace 304 (e.g., the content 342, which may include the inserted content 348). In some instances, it may be detected that the content 342 is in prose form and as such, suggested prompts may be provided based on the presence of prose form. In some instances, the content 342 within the workspace 304 is automatically provided to the model (e.g., by the cross-platform controller 210) for the model to parse the content and identify relevant details and generate or select suggested prompts, such as the suggested prompt 358. However, in some instances, the cross-platform controller 210 may identify and provide the suggested prompt 358 based on a type of the first application (e.g., document-based application), such as common prompts for such type of application, the enabled functions for the first application, the presence of content, the type of content (e.g., tables, paragraphs, pictures, etc.), and/or the like. Upon selection of the suggested prompt, the prompt may be provided to the model for content generation and/or modification of existing content within the workspace 304.

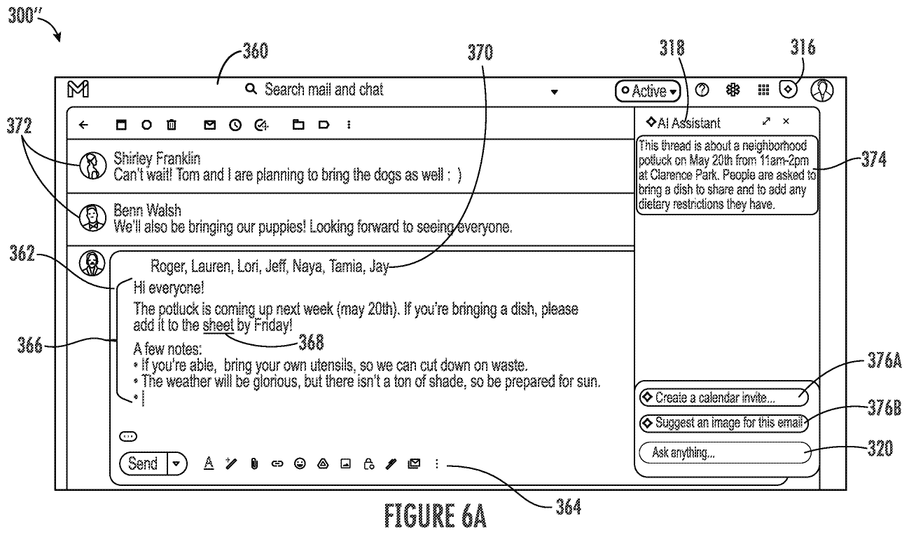

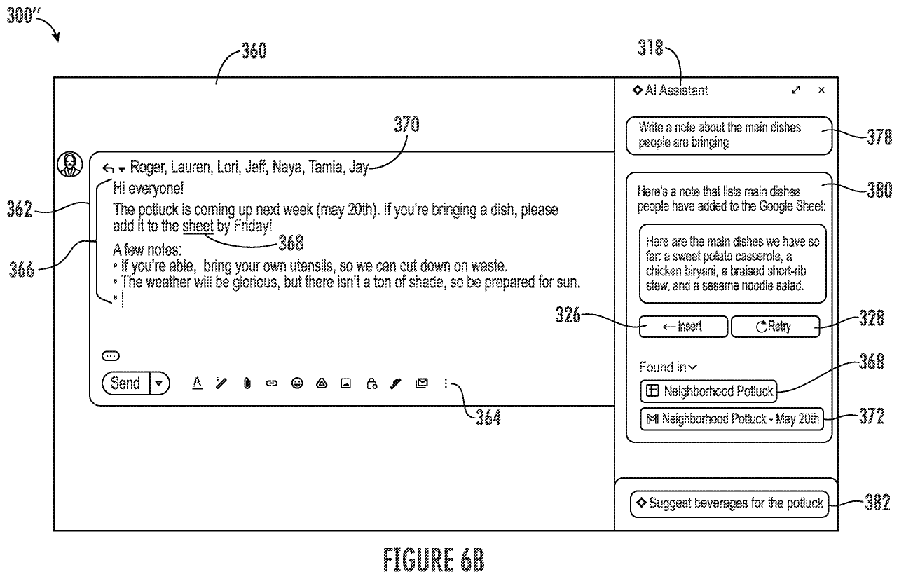

Turning now to FIGS. 6A-6B, example aspects of a user interface of another application of a productivity suite during another interaction 300″ for generation of context-aware content are illustrated. Particularly, in some instances, the application (e.g., second application 206B in FIG. 2) of the productivity suite may be an email application that includes or provides an item or object 360 (e.g., email) displayed on a user interface (e.g., user interface 206B in FIG. 2), such as via a user interface of one of the user computing device(s) 102 of FIG. 1A. The object 360 may be an email having a content generation environment or workspace 362 (similar to the workspace 304 described above with reference to FIGS. 4A-5C) configured to receive inputs (e.g., content such as text, images, and/or the like) from a user and provide or display such inputs in-line within the workspace 362. It should be appreciated that, as used herein, “in-line” is considered to mean content 366 within or insertable into the workspace 362 such that it is subject to formatting rules of the workspace 362 and/or embedded into the workspace 362. For instance, the object 360 may provide one or more format selection interface elements 364 with which a user may interact for selecting or defining formatting rules (e.g., font style, font size, font emphasis (e.g., bold, italicize, underline, color, highlight), hyperlinking, and/or the like) for content 366 (e.g., text) in-line within the workspace 362, attaching files (e.g., by reference to the file location and/or by attaching a copy), and/or the like. In some instances, the object 360 is configured as a communication with one or more other users. As such, the object 360 includes a field for selecting one or more recipients 370 which may be interacted with by a user for the user to view, add, and/or remove other recipients. In some instances, the object 360 is a chain of emails, including references to previous emails 372 for which the workspace 362 is used to generate a response to such previous emails 372.

In accordance with aspects of the present subject matter, as discussed above with reference to FIGS. 4A-5C, the model interaction environment 318 is similarly accessible by a user interacting with the object 360 in FIGS. 6A and 6B, such as by interacting with the assistant element 316, where the model interaction environment 318 again acts as a guiding digital assistant that allows a user to communicate with the generative model. Similar to as described above, the model interaction environment 318 may be broken-out or separated from the rest of the general workspace 362. For example, in the illustrated embodiments, the model interaction environment 318 is again configured as a side panel. However, it should be appreciated that the model interaction environment 318 may be provided in any other suitable format, such as a pop-up window, and/or the like and/or that the model interaction environment 318 may be interactable with from within the general workspace 362.

Similar to as discussed above, the content associated with the email application may additionally, or alternatively, be used to proactively generate a summary 374, as shown in FIG. 6A, without waiting for a user to request the summary. For instance, the content associated with the email application used to generate the summary 374 may include the content 366 generated by a user within the content generation environment 362, the previous emails 372 of the chain within the email chain 360, linked information (e.g., linked spreadsheet 368), the type of the application (e.g., email), and/or the like. The content associated with the email application may be fed to the generative model (e.g., by the cross-platform controller 210) with a request to generate a summary 374 of such content. Once the summary 374 is generated, the summary 374 may be provided to a user via the user interface, such as within the model interaction environment 318. In some instances, the summary 374 may be updated as the user continues to create and edit within the content generation environment 362 and/or as more emails 372 are received.

Moreover, a user may type or otherwise provide a prompt within the model interaction environment 318, such as within the prompt field 320, where the prompt may then be submitted to the model (e.g., via the cross-application controller 210, as described above). For instance, as shown in FIG. 6B, a user has submitted a user-generated prompt 378 (e.g., “Write a note about the main dishes people are bringing”). The content 366 may be provided with the user-generated prompt 378 to the generative model, where the generative model may use the content 366 to generate the response 380 to the prompt 378. In some instances, the previous emails in the chain 360 (e.g., previous emails 372 in FIG. 6A) may also be provided with the user-generated prompt 378 to the generative model for the generative model to use to generate the response 380. Moreover, in some instances, the type of the application may be supplied to the generative model, such as before or with the user-generated prompt 378, for the generative model to use the type of application to generate the response 380. In some instances, the generative model may be configured to access the linked spreadsheet 368 to use information within the linked spreadsheet 368 to generate the response 380. In such instances, the linked spreadsheet 368 may be an object (e.g., spreadsheet) of another application (e.g., of a cell-based application) to which the generative model has permission to access. For instance, the linked spreadsheet 368 may be part of a cell-based application of the same productivity suite as the email application. However, it should be appreciated that, in some instances, the cross-platform controller 210 may be configured to pass along required content from the linked spreadsheet 368. The linked spreadsheet 368 may serve as an implicitly implied reference in the example of FIG. 6B, as it was not explicitly identified within the user-generated prompt 378. The generated response 380 may be provided within model interaction environment 318. References to the sources used by the generative model to generate the response 380 may also be indicated with the response 380. For instance, the linked spreadsheet 368 from the email content 366 may again be linked within the model interaction environment 318 along with a link 372 to the email chain 370.

Additionally, in some instances, suggested prompts may be provided. For instance, the suggested prompts may be provided based at least in part on the content of the object 360 and/or the type of the application (e.g., email application). For example, in FIG. 6A, the suggested prompts include a first prompt 376A (e.g., “Create a calendar invite”) and a second prompt 376B (e.g., “Suggest an image for this email”). Moreover, in FIG. 6B, the suggested prompt includes a further prompt 382 (e.g., “Suggest beverages for the potluck”). As discussed above, suggested prompts may be generated by the generative model based at least in part on the content associated with the active application (e.g., the content 366 within the workspace 362, a link to the spreadsheet 368 provided within the workspace 362, the type of the application, functionalities of the application, and/or the like), or provided in any other suitable manner. For instance, suggested prompts may be selected (e.g., by the cross-application controller 210) based on common prompts for the type of application (e.g., common prompts for email applications by the user and/or other users). As an example, the first prompt 376A may be triggered based at least in part on the presence of a date in the content 366. Similarly, the prompt 382 may be provided based on common features of a potluck identified by the model. Upon selection of one of the suggested prompts, the prompt may be submitted to the generative model and the generative model may generate one or more responses, which may be provided via the model interaction environment 318.

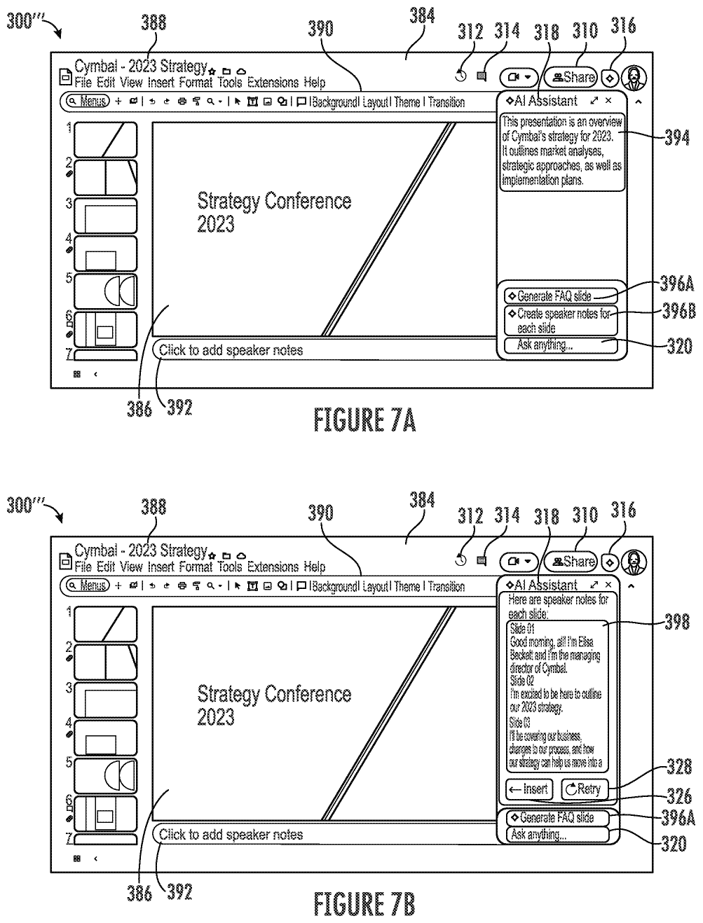

Turning now to FIGS. 7A-7B, example aspects of a user interface of a further application of a productivity suite during another interaction 300′″ for generation of context-aware content are illustrated. Particularly, in some instances, the application (e.g., third application 206C in FIG. 2) of the productivity suite may be a presentation application that includes or provides an item or object 384 (e.g., slide deck) displayed on a user interface (e.g., user interface 206C in FIG. 2), such as via a user interface of one of the user computing device(s) 102 of FIG. 1A. The object 384 may include a title field 388 (similar to title field 308 in FIGS. 4A-5C) for receiving and displaying a title (e.g., “Cymbal-2023 Strategy”) for the particular object 384. The object 384 may, for instance, be a slide deck having a content generation environment or workspace 386 (similar to the workspaces 304, 362 described above with reference to FIGS. 4A-6B), where the workspace 386 may be split across one or more slides, each slide being configured to receive inputs (e.g., content such as text, images, and/or the like) from a user and provide or display such inputs in-line within the workspace 386. In some instances, the workspace 386 may additionally include a speaker note field 392 associated with each of the slides. In one instance, the speaker notes from the speaker note fields 392 are displayed to a presentation giver, but not displayed to presentation viewers, during a presentation mode. It should be appreciated that, as used herein, “in-line” is considered to mean content within or insertable into the workspace 386 such that it is subject to formatting rules of the workspace 386 and/or embedded into the workspace 386. For instance, the object 384 may provide one or more format selection interface elements 390 with which a user may interact for selecting or defining formatting rules (e.g., font style, font size, font emphasis (e.g., bold, italicize, underline, color, highlight), background theme, slide layout, transition animations, and/or the like) for content in-line within the workspace 386. In some instances, the object 384 is configured as a collaborative object accessible, editable, and/or sharable by one or more other users, similar to as described above with reference to FIGS. 4A-5C.

In accordance with aspects of the present subject matter, as discussed above with reference to FIGS. 4A-6B, the model interaction environment 318 is similarly accessible by a user interacting with the object 384 in FIGS. 7A and 7B, such as by interacting with the assistant element 316, where the model interaction environment 318 again acts as a guiding digital assistant that allows a user to communicate with the generative model. Similar to as described above, the model interaction environment 318 may be broken-out or separated from the rest of the general workspace 386. For example, in the illustrated embodiments, the model interaction environment 318 is again configured as a side panel. However, it should be appreciated that the model interaction environment 318 may be provided in any other suitable format, such as a pop-up window, and/or the like and/or that the model interaction environment 318 may be interactable with from within the general workspace 386.

Similar to as discussed above, the content associated with the presentation application may be used to proactively generate a summary 394, as shown in FIG. 7A, without waiting for a user to request the summary. For instance, the content associated with the presentation application used to generate the summary 394 may include the content generated by a user within the content generation environment 386, the type of the application (e.g., presentation), and/or the like. The content associated with the presentation application may be fed to the generative model (e.g., by the cross-platform controller 210) with a request to generate a summary 394 of such content. Once the summary 394 is generated, the summary 394 may be provided to a user via the user interface, such as within the model interaction environment 318. In some instances, the summary 394 may be updated as the user continues to create and edit within the content generation environment 386.

Again, a user may type or otherwise provide a prompt within the model interaction environment 318, such as within the prompt field 320, where the prompt may then be submitted to the model (e.g., via the cross-application controller 210, as described above).

Additionally, in some instances, suggested prompts may be provided. For instance, the suggested prompts may be provided based at least in part on the content of the object 384 and/or the type of the application (e.g., presentation application). For example, in FIG. 7A, the suggested prompts include a first prompt 396A (e.g., “Generate FAQ slide”) and a second prompt 396B (e.g., “Create speaker notes for each slide”). As discussed above, suggested prompts may be generated by the generative model based at least in part on the content associated with the active application (e.g., the content within the workspace 386, the type of the application, functionalities of the application, and/or the like), or provided in any other suitable manner. For instance, suggested prompts may be selected (e.g., by the cross-application controller 210) based on common prompts for the type of application (e.g., common prompts for presentation applications by the user and/or other users). Upon selection of one of the suggested prompts, the prompt may be submitted to the generative model and the generative model may generate one or more responses, which may be provided via the model interaction environment 318. It should be appreciated that, the speaker notes 398 generated in response to the selection of the suggested prompt 396B in FIG. 7B may be automatically divided across the different slides upon request for insertion into the workspace 386 (i.e., into the speaker note fields 392 of the slides).

As such, it should be appreciated from the example interactions 300, 300′, 300″, 300″′ of FIGS. 4A-7B that the model interaction environment 318 is substantially the same in appearance across the different application types, but the content provided within the model interaction environment 318 is modified for the different application types such that the content generated by the generative model is automatically tailored to the type of application.

### Example Methods

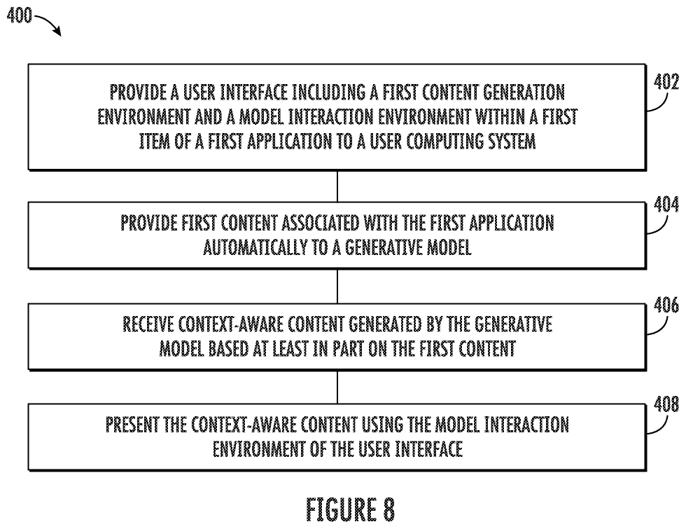

FIG. 8 depicts a flow chart diagram of an example method 400 for generating context-aware content across applications according to example embodiments of the present disclosure. Although FIG. 8 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system provides a user interface including a first content generation environment and a model interaction environment within a first item of a first application to a user computing system. For instance, as discussed above, a user interface including a content generation environment (e.g., such as the workspace 304 in FIGS. 4A-5C, the workspace 362 in FIGS. 6A-6B, or the workspace 386 in FIGS. 7A-7B) and a model interaction environment (e.g., the model interaction environment 318 in FIGS. 4A-7B) within an item or object of an application (e.g., such as the document 302 in FIGS. 4A-5C of the document-based application, the email 360 in FIGS. 6A-6B of the email application, or the presentation 384 in FIGS. 7A-7B of the presentation application) is provided to a user computing system, such as for display or other communication via a user interface of the user computing device 102 (FIG. 1A). The item may be stored or hosted on a server (e.g., server 130) and accessible by a user computing device (e.g., user computing device 102), or may be stored or hosted on a user computing device and have communication with a server.

At 404, the computing system provides first content associated with the first application automatically to a generative model. For example, as described above, content associated with the active application, such as the type and/or the enabled functionalities of the application, content within the content generation environment, and/or the like, may be provided automatically to a generative model. In some instances, the content associated with the active application may be supplied by the cross-platform controller 210 in FIG. 2 to the generative model (e.g., to the server 208 hosting the generative model).

At 406, the computing system receives context-aware content generated by the generative model based at least in part on the first content. For instance, as described above, the generative model may generate context-aware content generated based at least in part on the content associated with the active application. In some instances, the context-aware content is a summary of the content associated with the active application, one or more suggested prompts, and/or an answer to a user-generated prompt.

Additionally, at 408, the computing system presents the context-aware content using the model interaction environment of the user interface. For example, as discussed above, the generated context-aware content may be presented using the model interaction environment 318 of the user interface.

As such, context-aware content may be generated that is more relevant to the type of application and, in some cases, to a user's specific task within the application, without requiring additional user inputs and which significantly reduces the number of times that a generative model is prompted to create relevant content, thus, also reducing time and computing resources involved with prompting generative models.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system for generating context-aware content, the computing system comprising:
one or more processors; and
one or more non-transitory computer-readable media that collectively store instructions that, when executed by the one or more processors, cause the computing system to perform operations, the operations comprising:
providing a user interface to a user computing system, the user interface including a first content generation environment and a model interaction environment within a first item of a first application;
providing first content associated with the first application automatically to a generative model;
receiving context-aware content generated by the generative model based at least in part on the first content; and
presenting the context-aware content using the model interaction environment of the user interface.

2. The computing system of claim 1, wherein the first content comprises user-generated content within the first content generation environment, and
wherein the context-aware content comprises a summary of the first content.

3. The computing system of claim 1, wherein the first content comprises at least one of user-generated content within the first content generation environment or functionalities of the first application, and
wherein the context-aware content comprises a suggested prompt submittable to the generative model upon request by a user.

4. The computing system of claim 3, the operations further comprising:
receiving a request from the user via the user interface to submit the suggested prompt to the generative model;
providing the suggested prompt to the generative model;
receiving responsive content generated by the generative model in response to providing the suggested prompt to the generative model; and
presenting the responsive content via the user interface.

5. The computing system of claim 1, the operations further comprising:
receiving a user-generated prompt via the model interaction environment of the first application; and
submitting the user-generated prompt to the generative model,
wherein providing the first content associated with the first application automatically to the generative model comprises providing functionalities of the first application associated with the first application automatically to the generative model.

6. The computing system of claim 5, wherein providing the first content associated with the first application automatically to the generative model comprises providing the first content associated with the first application automatically to the generative model when submitting the user-generated prompt to the generative model.

7. The computing system of claim 5, wherein presenting the context-aware content comprises presenting the context-aware content with a reference to a source used by the generative model to create the context-aware content.

8. The computing system of claim 7, wherein the user-generated prompt specifies the source.

9. The computing system of claim 7, wherein the source is another item within the first application or an item of another application, the first application and the other application being part of a productivity suite.

10. A computer-implemented method for generating context-aware content, the computer-implemented method comprising:
providing, by a computing system, a user interface to a user computing system, the user interface including a first content generation environment and a model interaction environment within a first item of a first application;
providing, by the computing system, first content associated with the first application automatically to a generative model;
receiving, by the computing system, context-aware content generated by the generative model based at least in part on the first content; and
presenting, by the computing system, the context-aware content using the model interaction environment of the user interface.

11. The computer-implemented method of claim 10, wherein providing the first content comprises providing user-generated content within the first content generation environment, and
wherein receiving the context-aware content comprises receiving a summary of the first content.

12. The computer-implemented method of claim 10, wherein providing the first content comprises providing at least one of user-generated content within the first content generation environment or functionalities of the first application, and
wherein receiving the context-aware content comprises receiving a suggested prompt submittable to the generative model upon request by a user.

13. The computer-implemented method of claim 12, further comprising:
receiving, by the computing system, a request from the user via the user interface to submit the suggested prompt to the generative model;
providing, by the computing system, the suggested prompt to the generative model;
receiving, by the computing system, responsive content generated by the generative model in response to providing the suggested prompt to the generative model; and
presenting, by the computing system, the responsive content via the user interface.

14. The computer-implemented method of claim 10, further comprising:
receiving, by the computing system, a user-generated prompt via the model interaction environment of the first application; and
submitting, by the computing system, the user-generated prompt to the generative model,
wherein providing the first content associated with the first application automatically to the generative model comprises providing functionalities of the first application associated with the first application automatically to the generative model.

15. The computer-implemented method of claim 14, wherein presenting the context-aware content comprises presenting the context-aware content with a reference to a source used by the generative model to create the context-aware content.

16. One or more non-transitory computer-readable media that collectively store instructions that, when executed by one or more computing devices, cause the one or more computing devices to perform operations, the operations comprising:
providing a user interface to a user computing system, the user interface including a first content generation environment and a model interaction environment within a first item of a first application;
providing first content associated with the first application automatically to a generative model;
receiving context-aware content generated by the generative model based at least in part on the first content; and
presenting the context-aware content using the model interaction environment of the user interface.

17. The one or more non-transitory computer-readable media of claim 16, wherein the first content comprises user-generated content within the first content generation environment, and
wherein the context-aware content comprises a summary of the first content.

18. The one or more non-transitory computer-readable media of claim 16, wherein the first content comprises at least one of user-generated content within the first content generation environment or functionalities of the first application, and
wherein the context-aware content comprises a suggested prompt submittable to the generative model upon request by a user.

19. The one or more non-transitory computer-readable media of claim 16, the operations further comprising:
receiving a user-generated prompt via the model interaction environment of the first application; and
submitting the user-generated prompt to the generative model,
wherein providing the first content associated with the first application automatically to the generative model comprises providing functionalities of the first application associated with the first application automatically to the generative model.

20. The one or more non-transitory computer-readable media of claim 19, wherein presenting the context-aware content comprises presenting the context-aware content with a reference to a source used by the generative model to create the context-aware content.
